(19) United States
(12) Patent Application Publication
(10) Pub. No.: US 2014/0271093 A1
(43) Pub. Date: Sep. 18, 2014

(54) SELF-STRAPPING ROUND BALE TRAILER

(71) Applicant: POET RESEARCH, INC., Sioux Falls, SD (US)

(72) Inventor: Adam R. Wirt, Lennox, SD (US)

(21) Appl. No.: 13/826,878

(22) Filed: Mar. 14, 2013

(51) Int. Cl. B60P 7/08

(52) U.S. Cl. CPC B60P 7/0853
USPC 414/800; 410/32

(57) ABSTRACT

A bale retention system for retaining bales of material on a trailer, the system including a trailer with a horizontal trailer bed having first and second ends, a bale retention wall extending upwardly from the trailer bed and extending between the first and second ends of the trailer bed, and a trailer roller system including a first arm pivotably attached at its first end to a first structure at a first end of the trailer, a second arm pivotably attached at its first end to a second structure at a second end of the trailer, and a roller extending between and rotatably attached to a second end of the first and second arms. The roller system is actuatable so that the roller is moveable along an arcuate path extending from a point adjacent to a top surface of the bale retention wall to a point adjacent to the trailer bed.

### TECHNICAL FIELD

The present invention relates to equipment for moving bales of material on trucks, and more particularly relates to securing large bales of material on the bed of a trailer for safe transport of the bales.

### BACKGROUND

In recent years, there has been significant interest in the production of organic chemicals, such as ethanol, from fermentable sugars that are derived from cellulosic biomass. Useful cellulosic biomass includes, for example, corncobs, cornstover (e.g., stalks and leaves), switchgrass, wood chips, and other plant matter.

In order to facilitate the storage and transportation (e.g., to a cellulosic ethanol plant) of cellulosic biomass, the biomass is harvested from the field and is then formed into bales. Common bale configurations include “square bales” (e.g., a bale in the form of a rectangular cube typically measuring about 3′×4′×8′) and “round bales” (e.g., a bale in the form of a right circular cylinder typically measuring about 6 feet in diameter and 5 feet in width). To move these bales to locations where they can be processed further, such as cellulosic processing plants, the large bales are typically loaded onto flat open trailers and secured to those trailers with straps that are positioned over the bales. This securing process can be more straightforward with square bales than with round bales, but in either case, the process of positioning straps over the bales involves operators throwing straps over the bales, which requires throwing the straps approximately 14 feet in the air and then over two bales that span a distance of up to 12 feet (e.g., two round bales are each 5 feet wide, plus one foot on each side for clearance). If the strap does not land in a desired location relative to the bales, the operator will need to repeat the operation of throwing the strap. Thus, the process of securing bales to a trailer can be very labor intensive and time consuming. Thus, there is a desire to provide mechanisms and methods to secure bales to a flat trailer that minimizes the effort required from operators and that is also quicker and more repeatable, and that can be used for round bales that are stacked on top of and next to each other on a flat trailer.

### SUMMARY

In one aspect of the invention, a bale retention system is provided for retaining bales of material on a trailer. The system includes a trailer comprising a horizontal trailer bed having first and second ends spaced from each other along its length, a bale retention wall extending upwardly from the trailer bed and extending between the first and second ends of the trailer bed, and a trailer roller system comprising a first arm pivotably attached at its first end to a first structure at a first end of the trailer, a second arm pivotably attached at its first end to a second structure at a second end of the trailer, and a roller extending between and rotatably attached to a second end of the first and second arms. The trailer roller system is actuatable so that the roller is moveable along an arcuate path extending from a point adjacent to a top surface of the bale retention wall to a point adjacent to the horizontal trailer bed. The trailer roller system further includes a plurality of straps wrapped around the roller. In addition, the bale retention wall is moveable relative to a width of the horizontal trailer bed to accommodate bales of material that are wider than the width of the trailer bed itself.

### BRIEF DESCRIPTION OF THE DRAWINGS

The present invention will be further explained with reference to the appended Figures, wherein like structure is referred to by like numerals throughout the several views, and wherein:

FIG. 1 is a schematic side view of a trailer of the invention, which illustrates a bale retention wall;

FIG. 2 is a rear view of the trailer illustrated in FIG. 1, including an exemplary motion of an arm that carries straps over a plurality of bales;

FIG. 3 is a rear view of an empty trailer of the type illustrated in FIGS. 1 and 2, and showing two exemplary positions of the bale retention wall; and

FIG. 4 is another schematic side view of the trailer illustrated in FIG. 1, but viewed from the opposite side of the trailer.

### DETAILED DESCRIPTION

Referring now to the Figures, wherein the components are labeled with like numerals throughout the several Figures, an exemplary configuration of a trailer 10 is illustrated, which includes a horizontal bed 12 supported on its bottom side by a plurality of wheels 14 at a first end 18. The opposite or second end 20 of the trailer 10 includes a mechanism 15 that is attachable to a powered vehicle, such as a semi-trailer cab or the like. The trailer 10 may include wheels at additional locations along the length of the horizontal bed 12, if desired. The trailer 10 may include wheels 14 at both ends 18, 20 of the horizontal bed 12, if desired, in which case the trailer 10 may not need a mechanism 15. In any case, the trailer 10 further includes a vertical support wall 16 extending upwardly from the horizontal bed 12, and which is also referred to herein as a bale retention wall 16.

Bale retention wall 16 is provided as a support member for bales of material that are loaded on the trailer 10, therefore, the bale retention wall 16 can be provided with a height that is at least slightly larger than the total height of the bales that will be positioned on the horizontal bed 12. However, it is contemplated that the height of the bale retention wall is at least slightly less than the total height of the bales. The bale retention wall 16 can be made of a wide variety of materials, such as high strength steel, for example. The construction of the wall desirably will provide high strength to retain the bales securely on the trailer 10, but also to minimize the weight. That is, a material can be used that provides sufficient strength but is relatively light because any additional weight provided by the wall 16 will potentially impact the overall weight of the bales that can be hauled. Thus, the wall 16 can be provided with portions of varying strength along its length and/or the wall 16 can be corrugated or otherwise structured to provide the desired strength to support multiple bales.

The trailer 10 further includes a trailer roller system 30 that can have a number of different configurations. In the exemplary illustrated configuration, trailer roller system 30 includes a roller 32 that extends along the length of the trailer 10 and that is mechanically driven by at least one arm 34. The roller 32 includes a plurality of straps 40 mounted to it, which are rolled or coiled about the roller 32 when the straps 40 are in their stored or undeployed state. The roller system 30 may include arms 34 at both the first end 18 and the second end 20 of the trailer 10, wherein the roller 32 extends between both of the arms 34. Referring in particular to FIG. 2, a rear view of the trailer 10 is illustrated with multiple bales of material 50 loaded on the horizontal bed 12. As can be seen in this embodiment, the bales 50 are loaded so that two bales are next to each other across the width of the trailer 10 and are stacked to a height of two layers. Such an arrangement is not required, however, and differently sized bales can facilitate different stacking and loading arrangements, all of which are within the scope of the present invention.

After the desired number of bales 50 is loaded onto a trailer 10, securing the bales to the trailer can be accomplished by activating the trailer roller system 30. In particular, each of the arms 34 is rotatably attached to a frame structure at its respective end of the trailer 10, with the roller 32 located generally at the top of the bale retention wall 16. One end of each of the straps 40 can be attached to the bale retention wall 16. The roller system 30 can then be mechanically driven to rotate a free end of the arms 34 to move the roller 32 along a path 42 (illustrated in FIG. 2 with dashed lines). During this movement of the arms 34, the straps 40 will unroll from the roller 32, thereby positioning the straps on top of the bales 50. This movement can continue until the arms 34 reach the horizontal bed 12, or can stop at some point above the bed 12. In either case, the straps 40 can be completely unrolled and removed from the roller 32 so that the loose ends of the straps are accessible by an operator. The straps 40 can then be secured and tightened to the horizontal bed 12 or other attachment features of the lower area of the trailer 10. The arms 34 can then remain in this lower position or can be moved back to their location near the top of the bale retention wall 16. The loaded trailer 10 will then be ready for safe transport of the bales 50 to a desired location.

When the loaded trailer has reached its destination, the straps 40 can be removed from the bales 50 using an operation that is essentially the reverse of the operation used to position the straps over the bales. That is, the ends of the straps 40 can be released from the trailer 12 or other location to which they are attached, and then the loose end of each of these straps 40 is reattached to the roller 32, which will be positioned near the side of the trailer 10 opposite the bale retention wall 16. The roller system 30 can then be mechanically driven to rotate the roller 32 while the arm 34 is pivoting back up toward the bale retention wall 16 (i.e., along the path 42) so that the straps are being wrapped around the roller 32 as they are being removed from the bales 50. When the roller 32 reaches the top of the bale retention wall 16, the bales 50 will be free to be removed from the trailer 10 for processing. Using this process, the amount of interaction required between the operator and the straps is minimized for both securing and releasing the bales.

In accordance with the invention, the bale retention wall 16 can be moveable for at least a small distance relative to the width of the trailer 10, as is illustrated in FIG. 3. As shown, the bale retention wall 16 can be positioned closer to the center of the width of the trailer 10, and can also be translated to a position that is illustrated with a bale retention wall 16′ in order to accommodate wider bales 50. In one embodiment, the distance that the bale retention wall can move will be between 1 foot and 1.5 feet, although the distance the wall can move can be larger or smaller than this range. The movement of the wall 16 can be accomplished using a tube system that allows for the wall 16 to be moved outwardly upon an application of pressure or force, such as can be applied when loading heavy bales of material onto the trailer 10, or by mechanical means, such as hydraulically driven cylinders that move wall 16 toward and away from the center of the trailer 10. That is, when bales 50 are loaded onto the trailer 10, the can push the wall 16 in an outward direction to allow for an “overwidth” load, or a load that is wider than the width of the trailer itself. The bale retention wall 16 will thereby provide a secure backrest for the bales 50 to rest against and prevent further movement of the bales in that direction relative to the trailer. The use of this wall 16 also provides a retention mechanism on one side that can cooperate with the trailer roller system to retain bales 50 in multiple ways. After the bales 50 are removed from the trailer 10, the bale retention wall designated by reference number 16′ can move back to the location designated by the reference number 16. It is contemplated that these features can be retrofitted onto a flatbed or step deck trailer, and can be built to be a removable system, if desired.

While the above description is particularly discussed relative to cellulosic biomass, it is understood that the processes and equipment described herein can also be used for securing and transporting bales of different materials, such as bales of hay, straw, or other products.

The present invention has now been described with reference to several embodiments thereof. The entire disclosure of any patent or patent application identified herein is hereby incorporated by reference. The foregoing detailed description and examples have been given for clarity of understanding only. No unnecessary limitations are to be understood therefrom. It will be apparent to those skilled in the art that many changes can be made in the embodiments described without departing from the scope of the invention. Thus, the scope of the present invention should not be limited to the structures described herein, but only by the structures described by the language of the claims and the equivalents of those structures.

1. A bale retention system for retaining at least one bale on a trailer, the system comprising:
a trailer comprising a horizontal trailer bed having first and second ends spaced from each other along its length;
a bale retention wall extending upwardly from the trailer bed and extending between the first and second ends of the trailer bed; and
a trailer roller system comprising a first arm pivotably attached at its first end to a first structure at a first end of the trailer, a second arm pivotably attached at its first end to a second structure at a second end of the trailer, and a roller extending between and rotatably attached to a second end of the first and second arms;
wherein the trailer roller system is actuatable so that the roller is moveable along an arcuate path extending from a point adjacent to a top surface of the bale retention wall to a point adjacent to the horizontal trailer bed.

2. The bale retention system of claim 1, wherein the trailer roller system further comprises a plurality of straps wound around the roller.

3. The bale retention system of claim 1, wherein the bale retention wall is moveable relative to a width of the horizontal trailer bed.

4. The bale retention system of claim 3, further comprising a tube system that provides for the movement of the retention wall relative to the trailer bed width.

5. The bale retention system of claim 3, further comprising at least one hydraulic cylinder that provides for the movement of the retention wall relative to the trailer bed width.

6. The bale retention system of claim 1, in combination with a plurality of cylindrical bales, wherein the bales are arranged so that a second row of bales is stacked on top of a first row of bales.

7. The bale retention system of claim 6, wherein the bales are further arranged so that the first and second rows of bales are configured with two bales across the width of each row to correspond with a width of the horizontal trailer bed.

8. The bale retention system of claim 2, further comprising at least one attachment feature located on an opposite side of the trailer bed from the side from which the bale retention wall extends, wherein the at least one attachment feature is adapted for attachment of an end of each of the plurality of straps.

9. The bale retention system of claim 1, wherein the bale retention wall comprises high strength steel.

10. A method of securing a plurality of bales that have been loaded onto a trailer system, the method comprising the steps of:
loading a plurality of bales on a trailer comprising a horizontal trailer bed having a width and first and second ends spaced from each other along its length, a bale retention wall extending upwardly from the trailer bed and extending between the first and second ends of the trailer bed, and a trailer roller system comprising a first arm pivotably attached at its first end to a first structure at a first end of the trailer, a second arm pivotably attached at its first end to a second structure at a second end of the trailer, and a roller extending between and rotatably attached to a second end of the first and second arms;
actuating the trailer roller system to move the roller in a first direction along an arcuate path extending from a position adjacent to a top surface of the bale retention wall to a position adjacent to the horizontal trailer bed.

11. The method of claim 10, wherein the trailer roller system further comprises a plurality of straps wound around the roller and further comprising the step of unwinding the straps during the movement of the roller along the arcuate path.

12. The method of claim 11, further comprising the step of securing an end of each of the straps to at least one attachment feature of the trailer system.

13. The method of claim 10, wherein the plurality of bales comprises a plurality of cylindrical bales, wherein the bales are arranged so that a second row of bales is stacked on top of a first row of bales.

14. The method of claim 10, further comprising the step of moving the roller in a second direction along an arcuate path from the position adjacent to the horizontal trailer bed to the position adjacent to the top surface of the bale retention wall.

15. The method of claim 14, wherein the roller rotates to wind a plurality of straps onto the roller when traveling along the arcuate path in the second direction.
